(19) United States
(12) Patent Application Publication
(10) Pub. No.: US 2023/0352023 A1
(43) Pub. Date: Nov. 2, 2023

(54) METHOD FOR SUPPORTING ONLINE DIALOGUE, PROGRAM FOR CAUSING PROCESSOR TO EXECUTE THE METHOD FOR SUPPORTING, AND SUPPORT SYSTEM FOR ONLINE DIALOGUE

(71) Applicant: KONICA MINOLTA, INC., Tokyo (JP)

(72) Inventor: Kenji SAKAMOTO, Nishinomiya-shi (JP)

(73) Assignee: KONICA MINOLTA, INC., Tokyo (JP)

(21) Appl. No.: 18/295,888

(22) Filed: Apr. 5, 2023

(30) Foreign Application Priority Data
Apr. 27, 2022 (JP) 2022-073036

(51) Int. Cl. G10L 15/22; G10L 15/30; G10L 25/63

(52) U.S. Cl. CPC G10L 15/22; G10L 15/30; G10L 25/63

(57) ABSTRACT

A method for supporting online dialogue includes: receiving, by a computer, an utterance to a second speaker from a first speaker in an online dialogue; converting, by the computer, a voice of the utterance into a character string; analyzing, by the computer, the utterance; accessing, by the computer, a database having one or more utterance examples on a basis of a result of the analysis; extracting, by the computer, a desirable response as a response to the utterance by the first speaker from the one or more utterance examples on a basis of the utterance of the first speaker; and outputting, by the computer, the extracted utterance example to the second speaker.

The entire disclosure of Japanese patent Application No. 2022-073036, filed on Apr. 27, 2022, is incorporated herein by reference in its entirety.

### BACKGROUND

### Technological Field

The present disclosure relates to a technology for supporting online dialogue, and relates more specifically to a technology for proposing an utterance with high psychological safety.

### Description of the Related Art

A technology of holding a conference online is known. For example, JP 2017-215931 A discloses a “conference support system capable of improving conference efficiency”. This conference support system is to “input an utterance content that is a content of an utterance of a participant of the meeting, determine a type of a corresponding utterance on the basis of the utterance content input by the input unit, and output at least one of the utterance content, evaluation of the meeting, or evaluation of the participant on the basis of a determination result by the determination unit” (see [Abstract of the Disclosure]).

There are various utterances in response to the other party’s utterance in the dialogue, and for example, the utterance can be classified into utterance with high psychological safety and utterance without high psychological safety (low psychological safety) from the viewpoint of psychological safety. In order to promote desirable communication, there is a need for a technology in which utterances with high psychological safety are made through online dialogue.

### SUMMARY

The present disclosure has been made in view of the above-described background, and discloses a technology in which an utterance with high psychological safety is made in online dialogue.

To achieve the abovementioned object, according to an aspect of the present invention, a method for supporting online dialogue, reflecting one aspect of the present invention comprises: receiving, by a computer, an utterance to a second speaker from a first speaker in an online dialogue; converting, by the computer, a voice of the utterance into a character string; analyzing, by the computer, the utterance; accessing, by the computer, a database having one or more utterance examples on a basis of a result of the analysis; extracting, by the computer, a desirable response as a response to the utterance by the first speaker from the one or more utterance examples on a basis of the utterance of the first speaker; and outputting, by the computer, the extracted utterance example to the second speaker.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration and a usage mode of a server;

FIG. 2 is a block diagram illustrating a hardware configuration of a computer system;

FIG. 3 is a diagram illustrating an aspect of data storage in a hard disk included in the computer system functioning as the server;

FIG. 4 is a block diagram illustrating a functional configuration of a dialogue support system that provides a dialogue support function to terminals;

FIG. 5 is a diagram illustrating an example of a database managed in a hard disk of the server;

FIG. 6 is a flowchart illustrating a part of processing executed by the CPU of the server that implements the dialogue support system;

FIG. 7 is a diagram illustrating a data structure of the database according to another aspect;

FIG. 8 is a diagram illustrating an example of a configuration of the database according to another aspect; and

FIG. 9 is a diagram illustrating a screen displayed on a monitor of the computer system that achieves a terminal.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same parts are designated by the same reference numerals. Their names and functions are the same. Therefore, the detailed description of them will not be repeated.

### Overview of Features

As an overview of characteristics according to the present disclosure, in summary, in a case where a first speaker makes an utterance (for example, asks a question) and a second speaker makes an utterance as a response to the utterance (for example, in a case where an answer perceived as negative is made), when it is determined that the psychological safety of the utterance of the second speaker is not high, an utterance example similar to the utterance of the first speaker is extracted from the utterance of the first speaker and the past utterance database. The extracted utterance example does not need to completely match the immediately preceding utterance. The extraction is performed using, for example, an artificial intelligence (AI) technology, but the AI technology may not be used. For example, rule-based extraction may be performed.

In the present embodiment, the psychological safety refers to “a state in which it can be ensured that other members of the team do not reject or penalize his/her utterance” (Edmondson) in organizational behavior. In a case where the psychological safety is high, the speaker can believe that when the speaker proposes a question or an idea, the speaker will be accepted by the other party, so that the speaker can speak the question or the idea frankly.

The similar utterance example is presented as an utterance example with high psychological safety to the second speaker who made an utterance with low psychological safety. Thus, the second speaker can know preferable utterance examples for the utterance from the dialogue partner (first speaker), and thus action improvement in online dialogue can be facilitated.

Further, in a case where a plurality of utterance examples is registered in the utterance database, utterance examples having a high similarity to the utterance of the first speaker can be presented in the second utterance examples in order. By presenting a plurality of utterance examples, the second speaker can learn various utterance examples and acquire a richer communication ability.

Furthermore, in addition to an utterance example having high psychological safety, an utterance example determined to have low psychological safety may be presented. Since the utterance example with high psychological safety and the utterance example with low psychological safety are displayed, the second speaker can recognize the utterance example with low psychological safety as a negative example.

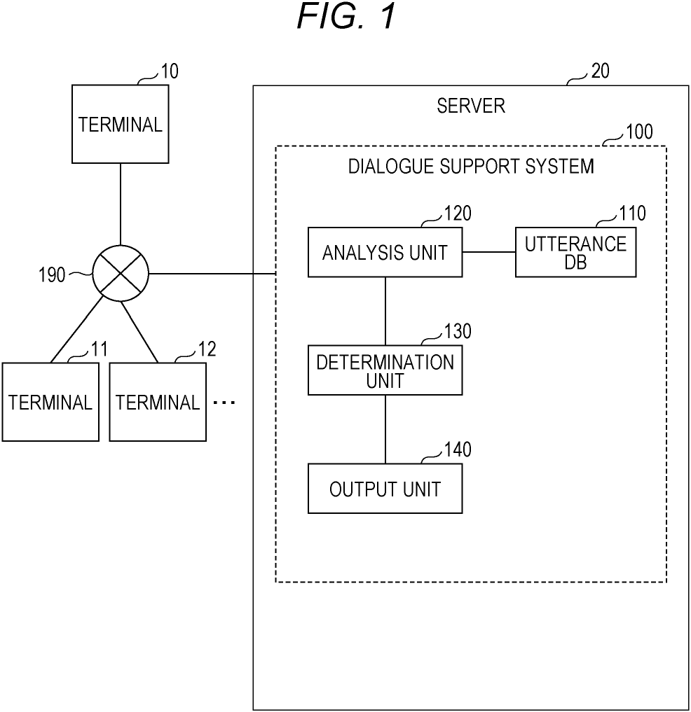

A configuration of a server 20 according to an embodiment will be described with reference to FIG. 1. FIG. 1 is a diagram illustrating a schematic configuration and a usage mode of the server 20. The server 20 communicates with terminals 10, 11, and 12, and the like via the network 190.

The server 20 includes a dialogue support system 100. The dialogue support system 100 includes an utterance database (DB) 110, an analysis unit 120, a determination unit 130, and an output unit 140. The dialogue support system 100 is implemented in an application used for web dialogue, such as Microsoft Teams (registered trademark), Zoom, or other WEB conference applications.

The utterance database 110 includes utterances by the user of the terminal 10 and registered utterance examples. The utterance by the user may be either voice data or character string data extracted from the voice data by voice recognition. The registered utterance example may include a certain utterance and a response utterance to the utterance. The utterance example can include an utterance input and registered by the user (operator, administrator, or the like) of the server 20 as an utterance that can be a reference for a response among dialogues actually performed via the server 20 and an utterance known to the public outside the server 20.

The analysis unit 120 analyzes the utterance on the basis of the voice data of the utterance received in the terminal 10 or 11. For example, the analysis unit 120 converts voice data into a character string using a known voice recognition technology, and analyzes the character string by morphological analysis. In an aspect, the analysis unit 120 can extract a term (for example, that’s impossible, it’s fine, it’ll be in time, or the like) for determining whether the psychological safety of the utterance is high or low by using the analysis result of the character string.

On the basis of the registered utterance example registered in the utterance database 110 and the utterance given from the terminal 10, the determination unit 130 determines whether or not the content of the utterance given from the terminal 11 as a response to the utterance is an utterance with high psychological safety.

As an example, in an aspect, the determination unit 130 decides whether the content of an answer is an utterance with high psychological safety or an utterance with low psychological safety based on an analysis result of the answer uttered by the user of the terminal 10 as a response to the utterance (for example, a question) of the user of the terminal 11. Upon determining that the content of the answer is an utterance with low psychological safety, the determination unit 130 searches the utterance database 110 for an utterance example similar to the answer of the user of the terminal 11.

The output unit 140 generates data for outputting a retrieved utterance example having high psychological safety, and transmits the data to the terminal 11. The terminal 11 can display an utterance example having high psychological safety or output an utterance example having high psychological safety as a voice on the basis of the data. The user can know an utterance example output by the terminal 11. Thus, in a case where the user makes a similar utterance (answer) in the future, the user can make an utterance (answer) having higher psychological safety than previous answers.

As another example, in another aspect, in a case where the user of the terminal 10 makes an utterance (for example, a question) to the user of the terminal 11, the analysis unit 120 performs speech recognition processing on the utterance and converts the utterance into a character string using a result of the speech recognition. The analysis unit 120 analyzes the content of the utterance by morphological analysis or the like of the character string. The determination unit 130 accesses the utterance database 110 using the analysis result of the contents of the utterance and searches for an utterance similar to the user’s utterance of the terminal 10. In a case where a similar utterance is registered in the utterance database 110, the determination unit 130 selects the similar utterance as an output possibility to the terminal 11. The determination unit 130 determines an utterance having high psychological safety among selected output possibilities as an output target for the terminal 11.

The output unit 140 generates data for causing the terminal 11 to output the utterance determined as the output target by the determination unit 130, and transmits the data to the terminal 11. The terminal 11 displays an utterance with high psychological safety on the basis of the data. The user of the terminal 11 can state an answer with high psychological safety as an answer to the utterance (question) by the user of the terminal 10 with reference to the display.

The network 190 may be either the Internet or an intranet, or may be a combination of the Internet and an intranet. The form of communication in the network 190 may be either wired or wireless.

According to an embodiment, since an utterance example having high psychological safety is presented to the user of the terminal, the user can recognize the utterance example having high psychological safety. Thus, it is also possible to expect improvement in behavior such that the user replies to the utterance of the dialogue partner with an utterance with high psychological safety. Improvement in productivity can also be expected by exchanging utterances with high psychological safety.

### [Configuration of Computer System]

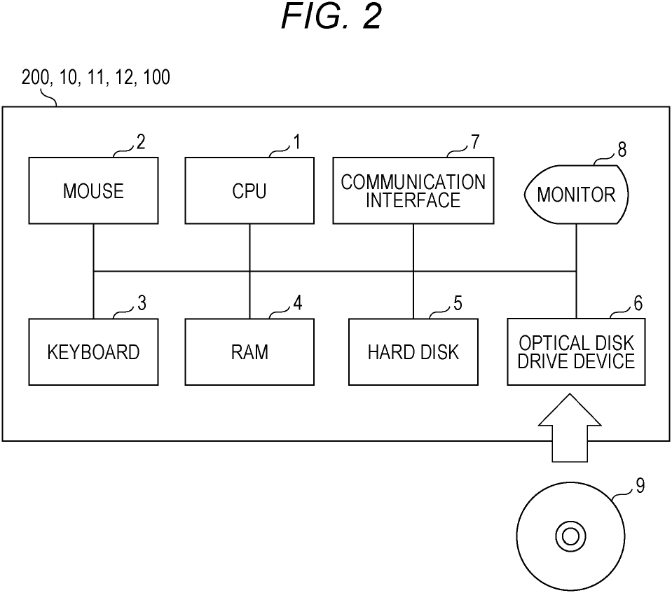

A configuration of a computer system 200 that is an aspect of an information processing apparatus will be described with reference to FIG. 2. FIG. 2 is a block diagram illustrating a hardware configuration of the computer system 200. The terminals 10 and 11 and the server 20 are implemented by the computer system 200.

The computer system 200 includes, as main components, a CPU 1 that executes a program, a mouse 2 and a keyboard 3 that receive an input of an instruction by a user of the computer system 200, a RAM 4 that volatilely stores data generated by the CPU 1 executing the program or data input via the mouse 2 or the keyboard 3, a hard disk 5 that non-volatilely stores data, an optical disk drive device 6, a communication interface (I/F) 7, and a monitor 8. The components are connected to each other by a data bus. A CD-ROM 9 and other optical disks are mounted on the optical disk drive device 6.

Processing in the computer system 200 is implemented by each piece of hardware and software executed by the CPU 1. Such software may be stored in advance in the hard disk 5. Further, the software may be stored in the CD-ROM 9 or another recording medium and distributed as a computer program. Alternatively, the software may be provided as an application program that can be downloaded by an information provider connected to what is called the Internet. Such software is once stored in the hard disk 5 after being read from the recording medium by the optical disk drive device 6 or another reading device or after being downloaded via the communication interface 7. The software is read from the hard disk 5 by the CPU 1 and stored in the RAM 4 in the form of an executable program. The CPU 1 executes the program.

Each component constituting the computer system 200 illustrated in FIG. 2 is a general component. Therefore, it can be said that one of essential parts of the technical idea according to the present disclosure is software stored in a recording medium such as the RAM 4, the hard disk 5, or the CD-ROM 9, or software that can be downloaded via a network. The recording medium may include a non-transitory computer-readable data recording medium. Note that, since the operation of each piece of hardware of the computer system 200 is well known, detailed description will not be repeated.

Note that the recording medium is not limited to a CD-ROM, a flexible disk (FD), or a hard disk, and may be a medium that fixedly carries a program, such as a magnetic tape, a cassette tape, an optical disk (Magnetic Optical Disc (MO)/Mini Disc (MD)/Digital Versatile Disc (DVD)), an integrated circuit (IC) card (including a memory card), a solid state drive (SSD), an optical card, a mask ROM, an electronically programmable read-only memory (EPROM), an electronically erasable programmable read-only memory (EEPROM), or a semiconductor memory such as a flash ROM.

The program referred to herein includes not only a program directly executable by the CPU but also a program in a source program format, a compressed program, an encrypted program, and the like.

### Data Structure

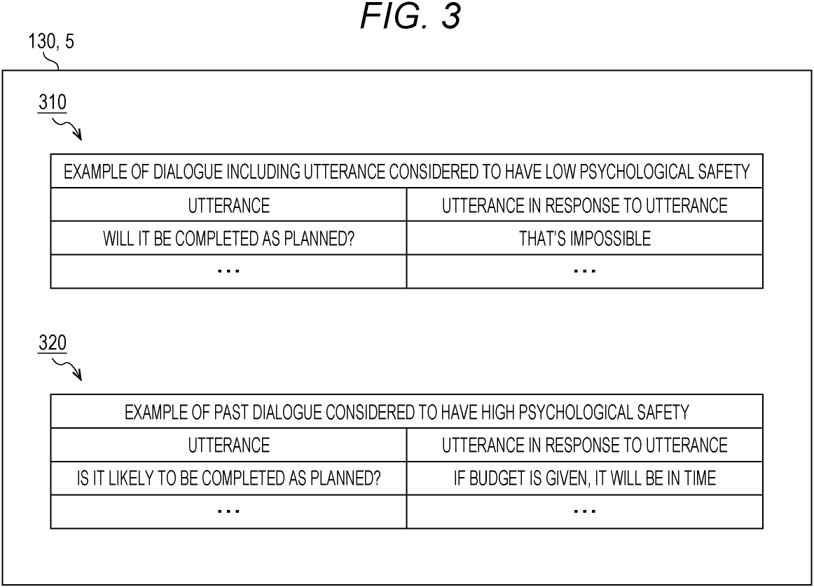

A data structure of the server 20 will be described with reference to FIG. 3. FIG. 3 is a diagram illustrating an aspect of data storage in the hard disk 5 included in the computer system 200 functioning as the server 20. The hard disk 5 stores the utterance database 110. The utterance database 110 includes tables 310 and 320.

The table 310 holds examples of dialogues including utterances considered to have low psychological safety. More specifically, the table 310 holds an utterance (for example, a question, a confirmation message, and the like) by the terminal (for example, the terminal 10) having made the first utterance and an answer (for example, utterance by the user of the terminal 11) to the utterance in association with each other. As an example, in a case where the user of the terminal 10 makes an inquiry of “will it be completed as planned?” to the user of the terminal 11 in a certain scene, since the user of the terminal 11 answered “impossible”, the table 310 holds a character string for the utterance of the inquiry and the answer.

The table 320 holds examples of past dialogues considered to have high psychological safety. More specifically, in a case where another user has answered “if budget is given, it will be in time” from another terminal to the user who has uttered “is it likely to be completed as planned?” in one terminal, the determination unit 130 determines that the answer is an utterance with high psychological safety. The determination unit 130 accesses the utterance database 110 and adds the utterance and answers to the table 320.

### Detailed Configuration

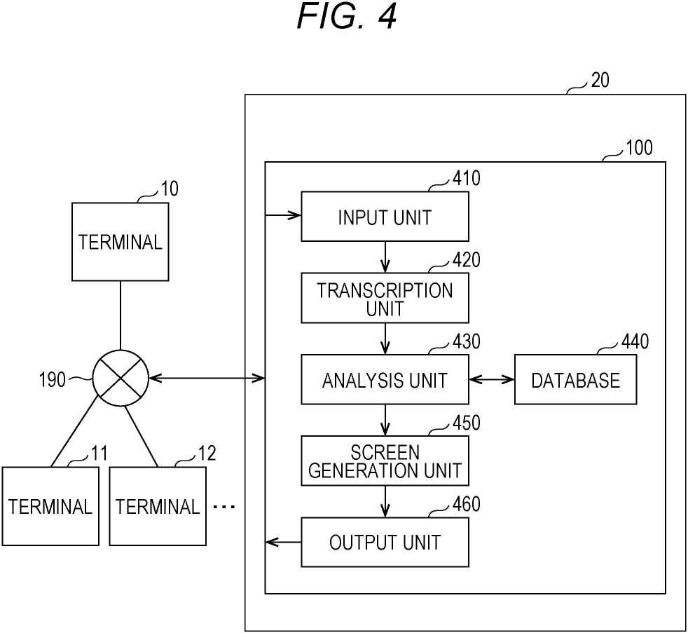

Details of the functions of the dialogue support system 100 will be described with reference to FIG. 4. FIG. 4 is a block diagram illustrating a functional configuration of the dialogue support system 100 that provides a dialogue support function to the terminals 10 and 11. The dialogue support system 100 includes an input unit 410, a transcription unit 420, an analysis unit 430, a database 440, a screen generation unit 450, and an output unit 460.

The input unit 410 receives an input of a voice signal of an utterance transmitted by each of the terminals 10 and 11. The input unit 410 is implemented by, for example, an input terminal connected to the network 190 and other reception interfaces.

The transcription unit 420 converts the voice signal into a character string. The analysis unit 430 analyzes the character string, determines whether or not the psychological safety of the utterance is high on the basis of specified criteria, and classifies the utterance. An example of the specified criteria may include an utterance designated or classified in advance by the administrator of the server 20 as an utterance with high psychological safety or an utterance with low psychological safety.

The database 440 holds the specified criteria, each utterance newly converted into a character string by the transcription unit 420 and classification information indicating the level of psychological safety of the utterance. Furthermore, the database 440 holds already known utterances and utterances designated by the administrator of the server 20 as utterances with high psychological safety, utterance examples with low psychological safety, and a notification message prepared in advance for prompting the terminals 10 and 11 to make a desirable utterance.

The screen generation unit 450 uses the result of the analysis unit 430 to generate data for causing the terminals 10 and 11 connected to the server 20 to display screens. The screen includes, as an example, a question received by a viewer (for example, the user of the terminal 11) of the screen, an answer made by the viewer, and an utterance example that is more desirable (that is, psychological safety is higher) as an answer when a question similar to the question is received. By displaying the utterance example, the viewer can know a more desirable utterance example, so that the psychological safety of the next and subsequent dialogues can be enhanced. Further, in a case where the more desirable utterance example is displayed before the viewer utters an answer, the viewer can return an answer considered to have high psychological safety from that time.

The output unit 460 transmits the data to the corresponding terminal. For example, when the user of the terminal 10 utters a question to the user of the terminal 11, the psychological safety of the answer of the user of the terminal 11 becomes a problem. Accordingly, the output unit 460 transmits the data to the terminal 11. The monitor 8 of the computer system 200 that implements the terminal 11 displays a screen on the basis of the data. For example, the screen may be displayed after the user of the terminal 11 makes an utterance, or may be displayed before the user of the terminal 10 makes an utterance in response to an utterance from the terminal 11.

### History of Utterances

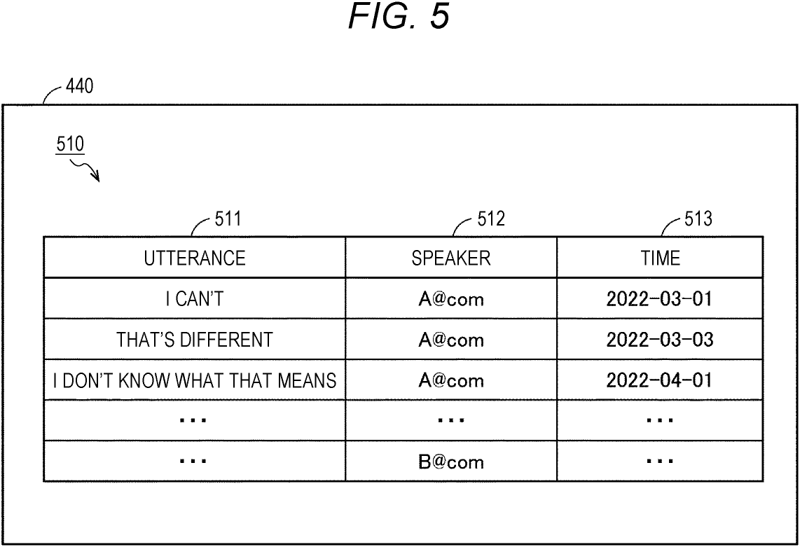

The data structure of the server 20 will be further described with reference to FIG. 5. FIG. 5 is a diagram illustrating an example of the database 440 managed in the hard disk 5 of the server 20. The database 440 holds a table 510. Table 510 includes utterance 511, speaker 512, and time 513.

The utterance 511 is an utterance by a user of each terminal (for example, the terminal 10 or the terminal 11) accessing the server 20. The speaker 512 identifies the user who has made the utterance. The speaker 512 is, for example, a mail address unique to the user who logs in to the dialogue support system 100 from each terminal, but other identification information (for example, a user number or the like) may be registered as the speaker 512. The time 513 specifies the time when the utterance is made.

When an utterance from each terminal is detected, the dialogue support system 100 converts the utterance into a character string by the transcription unit 420, and accumulates the utterance 511 obtained by analyzing the character string in the table 510 in the hard disk 5. Note that the table 510 may be stored in an external storage device connected to the server 20.

### Control Structure

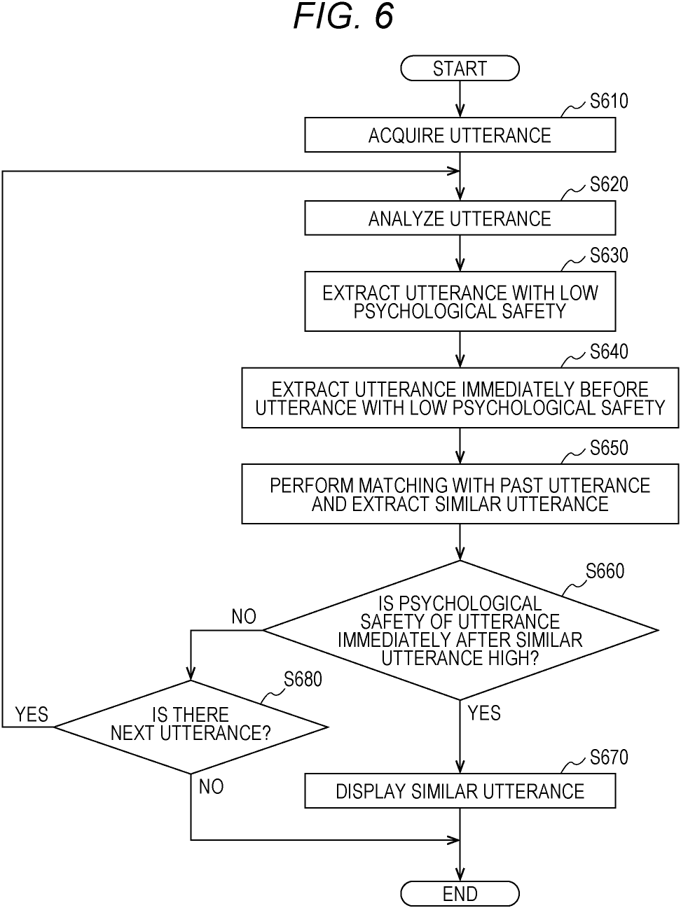

A control structure of the server 20 will be described with reference to FIG. 6. FIG. 6 is a flowchart illustrating a part of processing executed by the CPU 1 of the server 20 that implements the dialogue support system 100.

In step S610, the CPU 1 acquires an utterance made by the user of the terminal 11 via the input unit 410. For example, in a case where the user of the terminal 10 asks a question to the user of the terminal 11, an answer to the question may be the utterance made by the user of the terminal 11. Thereafter, the CPU 1, as the transcription unit 420, converts the voice signal of the utterance into a character string.

In step S620, the CPU 1 analyzes the utterance as the analysis unit 430. The analysis method is not particularly limited. Furthermore, the CPU 1 generates, as the screen generation unit 450, data for causing the terminal 11 to display a screen. The CPU 1 transmits the data to the terminal 11 via the output unit 460. The monitor 8 of the terminal 11 displays a screen representing an utterance with low psychological safety on the basis of the data. The user of the terminal 11 can know that his/her utterance has low psychological safety by viewing the screen.

In step S630, the CPU 1 extracts an utterance with low psychological safety as the analysis unit 430.

In step S640, the CPU 1 as the analysis unit 430 accesses the database 440 and extracts the utterance immediately before the utterance with low psychological safety. For example, in a case where the user of the terminal 10 makes an utterance and the user of the terminal 11 makes an utterance as an answer to the utterance, when it is determined that the psychological safety of the answer is low, the CPU 1 extracts the utterance by the terminal 10 as the utterance immediately before the utterance with low psychological safety.

In step S650, the CPU 1, as the analysis unit 430, accesses the database 440, performs matching between the immediately preceding utterance and past utterances, and extracts a similar utterance.

In step S660, the CPU 1 determines whether or not the psychological safety of the utterance immediately after the extracted similar utterance is high. This determination is made, for example, on the basis of whether or not the analysis result of the utterance includes a term regarded as having high psychological safety. Upon determining that the psychological safety of the immediately subsequent utterance is high (YES in step S660), the CPU 1 switches the control to step S670. Otherwise (NO in step S660), the CPU 1 switches the control to step S680.

In step S670, the CPU 1 causes the terminal 11 to display the similar utterance. More specifically, the CPU 1 generates, as the screen generation unit 450, data for causing the terminal to display the similar utterance, and transmits the data to the terminal 11 as the output unit 460. Upon receiving the data, the terminal 11 displays, on the monitor 8, an example of an utterance considered to have high psychological safety among utterances similar to the utterance by the user of the terminal 11. Thus, the user can know an utterance that is considered to have high psychological safety, so that the psychological safety of future dialogue can be enhanced.

In step S680, the CPU 1 determines whether or not there is the next utterance as an utterance that can be an analysis target. This determination is made, for example, on the basis of a determination result as to whether or not the character string includes a plurality of utterances as a result of analysis by the analysis unit 430. In a case where the character string corresponding to the voice of the utterance includes a plurality of utterances, the CPU 1 can determine that there is the next utterance. Upon determining that there is the next utterance (YES in step S680), the CPU 1 returns the control to step S620. Otherwise (NO in step S680), the CPU 1 ends the process.

### Modification Example

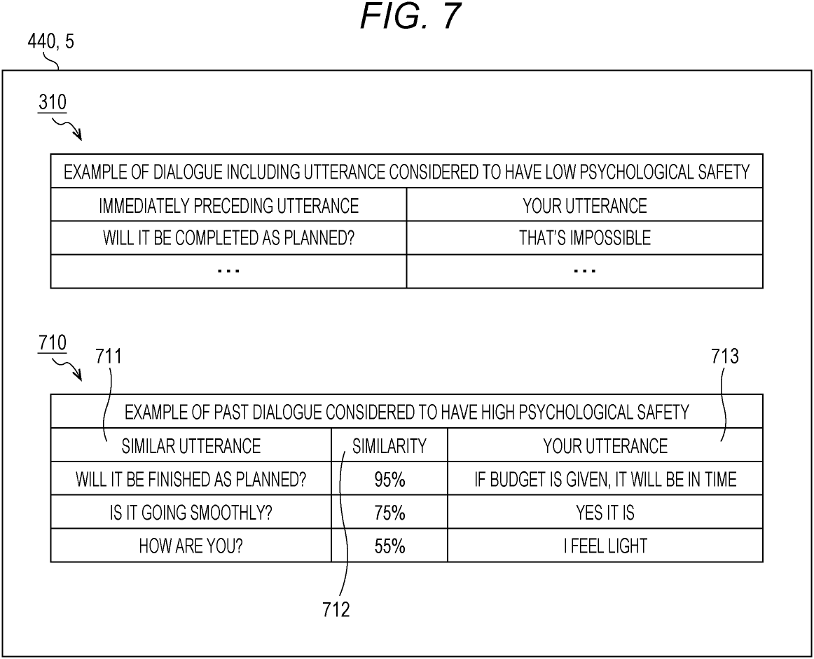

An example of another aspect will be described with reference to FIG. 7. FIG. 7 is a diagram illustrating a data structure of a database 440 according to another aspect.

In an aspect, a plurality of utterances may be stored in the database 440 as utterances with high psychological safety. In this case, if more than necessary utterances are displayed on the terminal as utterances with high psychological safety, the user of the terminal may be confused. Therefore, in an aspect, among utterances similar to the immediately preceding utterance, utterances having a similarity equal to or higher than a preset reference value may be preferentially displayed for the user of the terminal. In the present embodiment, the similarity is calculated by, for example, a Levenshtein distance, a Jaro-Winkler distance, or other known methods.

As illustrated in FIG. 7, the database 440 of the dialogue support system 100 according to another aspect further stores a table 710 in addition to a table 310. The table 710 includes examples of past dialogues considered to have high psychological safety. That is, the table 710 includes regions 711, 712, and 713. The region 711 holds an utterance similar to an utterance by the user of the terminal. The region 712 holds the similarity between the utterance by the user and the similar utterance. The region 713 holds an utterance possibility that can be suggested to the user of the terminal.

For example, in a case where it is set in the dialogue support system 100 to display two dialogue examples from a past dialogue example considered to have high psychological safety in a case where utterance of “will it be completed as planned?” illustrated in the table 310 is given from the user of the terminal 10 to the user of the terminal 11, the CPU 1 selects “will it be finished as planned?” and “is it going smoothly?” as two similar utterances in 710 descending order of similarity, extracts two utterances corresponding to the selected similar utterance from the region 713, and displays the two extracted utterances on the terminal 11. Thus, since the user of the terminal 11 can confirm a plurality of utterances, the user can answer an utterance with high psychological safety according to the content of the dialogue.

### Well-Known Utterances

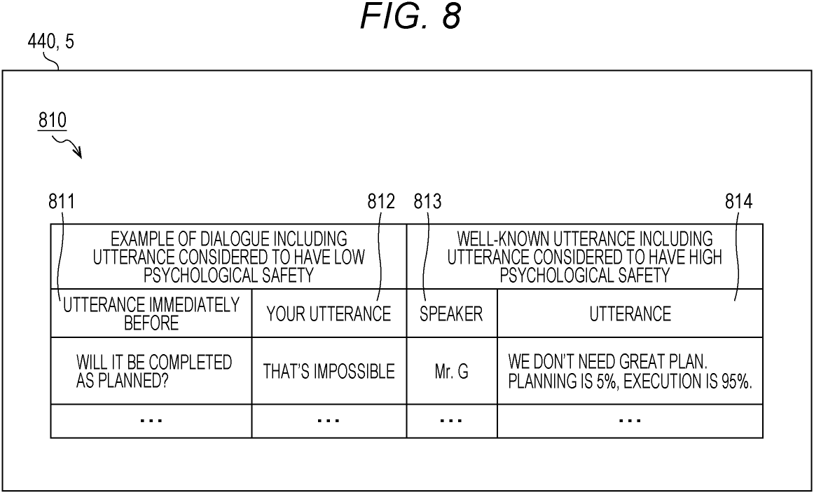

Still another example will be described with reference to FIG. 8. In an aspect, there is a possibility that no similar utterance having a high similarity is registered in the database depending on the contents of the utterance. In that case, a well-known utterance widely known in the public may be presented to the user of the terminal as an utterance possibility that can be used for a response.

FIG. 8 is a diagram illustrating an example of a configuration of a database 440 according to another aspect. The database 440 includes a table 810. The table 810 includes regions 811, 812, 813, and 814.

The region 811 holds an immediately preceding dialogue to be a trigger among dialogues including utterances considered to have low psychological safety. The region 812 holds an utterance of the user answered to the immediately preceding dialogue. The region 813 holds identification information (real name, stage name, pen name, and the like) of a speaker of well-known utterances widely known in the public including utterances considered to have high psychological safety. The region 814 holds the utterances. The well-known utterances are registered in the database 440 by the creator or the administrator of the dialogue support system 100.

According to the table 810, even in a case where there is no utterance having a high similarity with respect to the utterance (the region 811) actually given by the user of the terminal, the CPU 1 can extract an utterance from the well-known utterances (the region 814) considered to have high psychological safety and display the extracted utterance on the terminal. Thus, the user can know an ideal utterance considered to have high psychological safety among utterances widely known in the public, so that the user can make an answer based on the ideal utterance as a subsequent answer.

### Screen Example

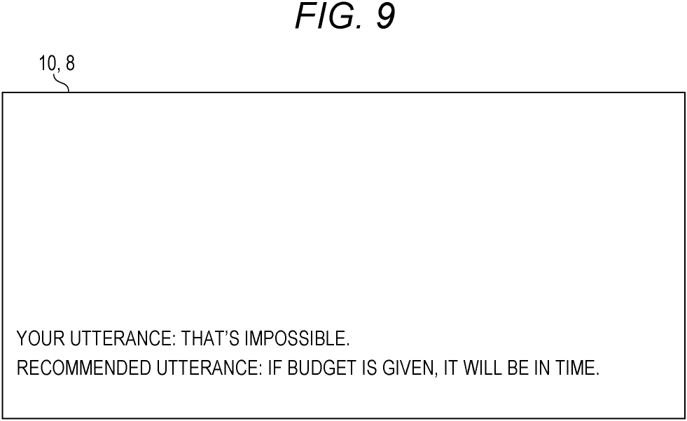

A display example of a screen in the terminal 10 will be described with reference to FIG. 9. FIG. 9 is a diagram illustrating a screen displayed on the monitor 8 of the computer system 200 that implements the terminal 10. The monitor 8 displays an utterance of the user of the terminal 10 and a recommended utterance. Thus, the user can compare his/her own utterance with the ideal utterance, so that the content of the subsequent utterance can be improved to an utterance with higher psychological safety.

### Summary

Some of the technical features disclosed above may be summarized as follows.

[Configuration Example 1] According to an embodiment, a method of supporting online dialogue is provided. This supporting method includes the steps of: receiving, by the CPU 1, an utterance to a second speaker (terminal 11) from a first speaker (terminal 10) in an online dialogue; converting, by the CPU 1, a voice of the utterance into a character string; analyzing, by the CPU 1, the utterance; accessing, by the CPU 1, a database (for example, the utterance database 110 and the database 440) having one or more utterance examples on the basis of a result of the analysis; extracting, by the CPU 1, a desirable response as a response to the utterance by the first speaker from the one or more utterance examples on the basis of the utterance of the first speaker; and outputting, by the CPU 1, the extracted utterance example to the terminal 11 of the second speaker.

[Configuration Example 2] According to an aspect, in addition to the configuration example described above, the online dialogue support method further includes a step of receiving a response to the utterance by the first speaker from the second speaker. The extracting step includes a step of extracting a response to the utterance by the first speaker on the basis of the response by the second speaker. The presenting step includes presenting the extracted utterance example on the monitor 8 of the terminal 11 of the second speaker after receiving an input of a response to the first speaker from the second speaker.

[Configuration Example 3] In an aspect, in addition to the above configuration example, the presenting step includes a step of presenting the utterance example on a monitor 8 used by a second speaker before a response from the second speaker to the first speaker is made.

[Configuration Example 4] In an aspect, in addition to the above configuration example, the analyzing step includes a step of determining whether or not an utterance input to the CPU 1 is psychological safe.

[Configuration Example 5] In an aspect, in addition to the above configuration example, the extracting step includes a step of searching for a past utterance similar to the utterance of the first speaker, and a step of selecting an utterance that is determined to be psychologically safe as a response to the past utterance.

[Configuration Example 6] In an aspect, in addition to the above configuration example, the database includes a plurality of utterance examples. The utterance examples includes an utterance extracted from a dialogue performed in the past using the dialogue support system 100 or a publicly known utterance input by the administrator of the dialogue support system 100. The selecting step includes a step of searching for an utterance example having a high similarity to the utterance by the first speaker from the plurality of utterance examples. The similarity is calculated by a known method. The outputting step includes a step of outputting the utterance example having a high similarity to the second speaker on the basis of that the utterance example having a high similarity has been retrieved. Alternatively, only an utterance example having a similarity exceeding a preset threshold may be selectively presented to the second speaker.

[Configuration Example 7] In an aspect, in addition to the above configuration example, the plurality of utterance examples include an utterance with high psychological safety among utterance examples known to the public. The outputting step includes a step of displaying an utterance example known to the public on the monitor of the terminal 11 of the second speaker on the basis of that the utterance example having a high similarity has not been extracted.

[Configuration Example 8] In an aspect, in addition to the above configuration example, the outputting step includes a step of outputting an utterance example having a high similarity and an utterance example considered to have high psychological safety as an utterance for the utterance example. For example, the monitor 8 displays the utterance example with the high similarity and the utterance example with high psychological safety side by side.

According to the above embodiment, in a case where the next utterance is made for a certain utterance, when the psychological safety of the next utterance is determined to be low, an ideal utterance example for the certain utterance is presented to the speaker who made the next utterance. The speaker can improve the subsequent utterance by referring to the utterance example.

In another aspect, when an utterance of the first speaker (for example, the user of the terminal 10) is input to the dialogue support system 100, the dialogue support system 100 analyzes the utterance and extracts an utterance example that is considered to have high psychological safety from the utterance database 110. The dialogue support system 100 outputs the utterance of the first speaker to the second speaker (for example, the user of the terminal 11) who is the other party by voice, and displays the extracted utterance example on the monitor 8 of the terminal 11. This increases the possibility that the second speaker can make an utterance with high psychological safety to the first speaker, so that the quality of communication in the online dialogue can be improved.

Although embodiments of the present invention have been described and illustrated in detail, the disclosed embodiments are made for purposes of illustration and example only and not limitation. The scope of the present invention should be interpreted by terms of the appended claims, and it is intended that all modifications are included in the meaning and scope equivalent to the claims.

The disclosed technology can be applied to an online conference system and other systems in which online dialogue is performed.

What is claimed is:

1. A method for supporting online dialogue, the method comprising:
receiving, by a computer, an utterance to a second speaker from a first speaker in an online dialogue;
converting, by the computer, a voice of the utterance into a character string;
analyzing, by the computer, the utterance;
accessing, by the computer, a database having one or more utterance examples on a basis of a result of the analysis;
extracting, by the computer, a desirable response as a response to the utterance by the first speaker from the one or more utterance examples on a basis of the utterance of the first speaker; and
outputting, by the computer, the extracted utterance example to the second speaker.

2. The method for supporting online dialogue according to claim 1, further comprising
receiving a response to the utterance by the first speaker from the second speaker, wherein
the extracting includes extracting a response to the utterance by the first speaker on a basis of the response by the second speaker, and
the presenting includes presenting the extracted utterance example to the second speaker after receiving an input of a response to the first speaker from the second speaker.

3. The method for supporting online dialogue according to claim 1, wherein
the presenting includes presenting the utterance example before a response from the second speaker to the first speaker is made.

4. The method for supporting online dialogue according to claim 1, wherein
the analyzing includes determining whether or not an utterance input to the computer is psychologically safe.

5. The method for supporting online dialogue according to claim 1, wherein
the extracting includes
searching for a past utterance similar to the utterance of the first speaker; and
selecting an utterance that is determined to be psychologically safe as a response to the past utterance.

6. The method for supporting online dialogue according to claim 5, wherein
the database includes a plurality of utterance examples,
the selecting includes searching for an utterance example having a high similarity to the utterance by the first speaker from the plurality of utterance examples, and
the outputting includes outputting the utterance example having a high similarity to the second speaker on a basis of that the utterance example having a high similarity has been retrieved.

7. The method for supporting online dialogue according to claim 6, wherein
the plurality of utterance examples includes an utterance with high psychological safety among utterance examples known to public, and
the outputting includes outputting the utterance example known to public to the second speaker on a basis of that the utterance example having a high similarity has not been extracted.

8. The method for supporting online dialogue according to claim 5, wherein
the outputting includes outputting an utterance example having a high similarity and an utterance example considered to have high psychological safety as an utterance for the utterance example.

9. A non-transitory recording medium storing a computer readable program for causing a processor to execute the supporting method according to claim 1.

10. A support system for online dialogue, comprising:
a memory storing a computer readable program for implementing the supporting method according to claim 1; and
a processor that executes the computer readable program.
